(19) United States
(12) Patent Application Publication
(10) Pub. No.: US 2026/0332875 A1
(43) Pub. Date: Oct. 22, 2026

(54) CAMERA MODULE AND VEHICLE COMPRISING SAME

(71) Applicant: LG INNOTEK CO., LTD., Seoul (KR)

(72) Inventors: Sung Jin PARK, Seoul (KR); Seung Won SEOK, Seoul (KR); Jun Young LIM, Seoul (KR)

(21) Appl. No.: 19/109,777

(22) PCT Filed: Sep. 7, 2023
(86) PCT No.: PCT/KR2023/013459

§ 371 Date: Mar. 7, 2025

(30) Foreign Application Priority Data
Sep. 7, 2022 (KR) 10-2022-0113743

(51) Int. Cl. H04N 23/57; G02B 7/02; H04N 23/51; H04N 23/52; H04N 23/55

(52) U.S. Cl. CPC H04N 23/57; G02B 7/021; H04N 23/51; H04N 23/52; H04N 23/55

(57) ABSTRACT

A camera module disclosed in an embodiment of the invention includes a lens barrel penetrating from an upper portion to a lower portion; a plurality of inner barrels disposed around an inner circumference of the lens barrel; and a lens portion having a plurality of lenses disposed inside the inner barrel, wherein at least one of the plurality of inner barrels is disposed between two adjacent lenses and may be disposed between outer surfaces of the two adjacent lenses and the lens barrel.

### TECHNICAL FIELD

An embodiment of the invention relates to a camera module and a vehicle having the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like.

Sensor devices for sensing the situation ahead in ADAS include GPS sensors, laser scanners, front radar, and Lidar, but the most representative one is the front camera for filming the front of the vehicle. Recently, research on detection systems that detect the surroundings of the vehicle for driver safety and convenience is accelerating. The vehicle detection systems are used for various purposes, such as detecting objects around the vehicle to prevent collisions with objects that the driver does not recognize, as well as performing automatic parking by detecting empty spaces, and provide the most essential data for automatic vehicle control. In such a detection system, a method using a radar signal and a method using a camera are commonly used.

Vehicle camera modules are built into front and rear surveillance cameras and black boxes in cars and are used to capture subjects in photos or videos. Since vehicle camera modules are exposed to the outside, photographing quality may deteriorate due to moisture and temperature. In particular, camera modules have a problem in that their optical characteristics change depending on the surrounding temperature and the material of the lens.

### DISCLOSURE

### Technical Problem

A camera module according to an embodiment of the invention may provide a camera module having an inner barrel on one side or an entire inner surface of the lens barrel. An embodiment of the invention may provide a camera module having a plurality of inner barrels around different lenses of the lens barrel. An embodiment of the invention may provide a camera module having a first inner barrel in contact with an outer surface of at least one lens of the lens barrel and a second inner barrel in contact with an outer surface of the at least one lens.

An embodiment of the invention may provide a camera module having a plurality of inner barrels each disposed between an outer surface of at least one or two or more lenses and the lens barrel. An embodiment of the invention may provide a camera module in which a plurality of inner barrels has a material different from that of the lens barrel. An embodiment of the invention may provide a mobile terminal such as a mobile terminal and a vehicle having a camera module.

### Technical Solution

A camera module according to an embodiment of the invention includes a lens barrel penetrating from an upper portion to a lower portion; a plurality of inner barrels disposed around an inner circumference of the lens barrel; and a lens portion having a plurality of lenses disposed inside the inner barrel, wherein at least one of the plurality of inner barrels is disposed between two adjacent lenses and may be disposed between outer surfaces of the two adjacent lenses and the lens barrel.

According to an embodiment of the invention, the plurality of inner barrels includes a first inner barrel extending from an outer surface of a first lens closest to an object to an outer surface of a second lens located on a sensor side of the first lens, and a second lens barrel extending from an outer surface of a third lens located on a sensor side of the second lens to an outer surface of a last lens.

According to an embodiment of the invention, a lower portion of the first inner barrel may include a first support spacer extending between a flange portion of the second lens and a flange portion of the third lens. A distance between an upper end of an outer side of the first inner barrel and the lens barrel may be narrower than a distance between the lens barrel and an outer surface of the first inner barrel disposed outside a region between the first lens and the second lens.

According to an embodiment of the invention, an upper portion of the second inner barrel may extend outside the first support spacer. The second inner barrel may include a second support spacer extending below a flange portion of the last lens.

According to an embodiment of the invention, the distance between the outer surface of the second inner barrel and the inner surface of the lens barrel may gradually widen from the outer surface of the third lens to the outer surface of the seventh lens. An inner diameter of the second inner barrel gradually narrows from the upper portion toward the last lens, and the inner and outer surfaces of the second inner barrel may have a plurality of stepped structures.

According to an embodiment of the invention, at least one of the plurality of inner barrels may be made of a plastic material, and at least one of the plurality of lenses may be made of a plastic material. The lens barrel may be made of a metal material, the first and second inner barrels may be made of a plastic material, and at least two lenses disposed in the second inner barrel may be made of a plastic material.

According to an embodiment of the invention, at least one of a first spacer that separates two adjacent lenses in the first inner barrel and a second spacer that separates two adjacent lenses in the second inner barrel may include. According to an embodiment of the invention, an image sensor disposed on a sensor side of the lens barrel; a cover glass disposed on the image sensor; and an optical filter disposed between the cover glass and a lens closest to the image sensor.

A vehicle according to an embodiment of the invention includes a camera module having a plurality of lenses, a plurality of inner barrels outside the plurality of lenses, a lens barrel outside the plurality of inner barrels, and a camera module having an image sensor disposed on the sensor side of the lens barrel, wherein at least two lenses of the plurality of inner barrels and the plurality of lenses are made of plastic, and the plurality of inner barrels may overlap in a direction of an optical axis.

### Advantageous Effects

According to an embodiment of the invention, it is possible to provide a camera module that may maintain resolution according to temperature changes by stacking lenses in heterogeneous barrels. That is, a camera module with the heterogeneous barrels may minimize stress and decentering of a lens, such as a plastic lens, that expands due to temperature changes. According to an embodiment of the invention, by providing a plurality of inner barrels within the lens barrel, it is possible to provide a camera module that may maintain the resolution of the optical system and suppress deformation of the lenses due to temperature changes. According to an embodiment of the invention, the optical reliability of a camera module may be improved and the reliability of a vehicle camera device having a camera module may be improved.

### DESCRIPTION OF DRAWINGS

FIG. 1 is a side cross-sectional view of a camera module according to an embodiment of the invention.

FIG. 2 is a diagram showing an upper region of the lens barrel in the camera module of FIG. 1.

FIG. 3 is a diagram explaining an example of coupling the first and second inner barrels of the camera module of FIG. 1.

FIG. 4 is a diagram showing a lower region of the camera module of FIG. 1.

FIG. 5 is a cross-sectional view illustrating an example of coupling a cover on a lens barrel according to an embodiment of the invention.

FIG. 6 is an example of a vehicle having a camera module according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected” , “coupled” or “joined” to another component, the description may include not only being directly connected, coupled or joined to the other component but also being “connected” , “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Additionally, several embodiments described below can be combined with each other, unless specifically stated that they cannot be combined with each other. Additionally, unless specifically mentioned, parts omitted from the description of one of several embodiments may be applied to the description of other embodiments.

In the description of the invention, the first lens refers to the lens closest to the object side, and the last lens refers to the lens closest to the image side (or sensor surface). The last lens may include a lens adjacent to the image sensor. Unless otherwise specified in the description of the invention, the units for lens radius, thickness/distance, TTL, etc. are all mm. In this specification, the shape of the lens is expressed based on the optical axis of the lens. For example, saying that the object side of the lens is convex or concave means that the object side of the lens is convex or concave around the optical axis, but does not mean that the area around the optical axis is convex or concave. Therefore, even if the object side of the lens is described as convex, the portion around the optical axis on the object side of the lens may be concave or the opposite shape. In this specification, it should be noted that the thickness and radius of curvature of the lens are measured based on the optical axis of the lens. In other words, a convex lens surface means that the lens surface in the area corresponding to the optical axis has a convex shape, and a concave lens surface means that the lens surface in the area corresponding to the optical axis has a concave shape. can do. In addition, “object-side surface” may refer to the surface of the lens facing the object side based on the optical axis, and “sensor-side surface” may refer to the surface of the lens facing the sensor side based on the optical axis.

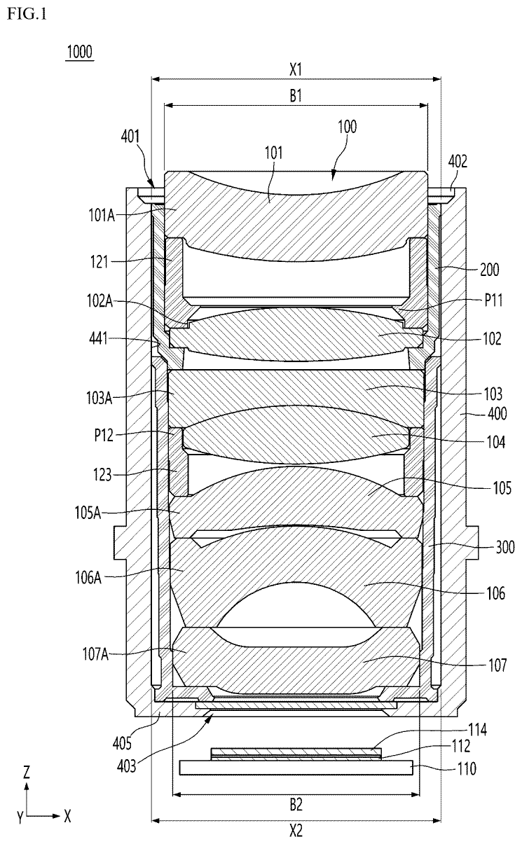

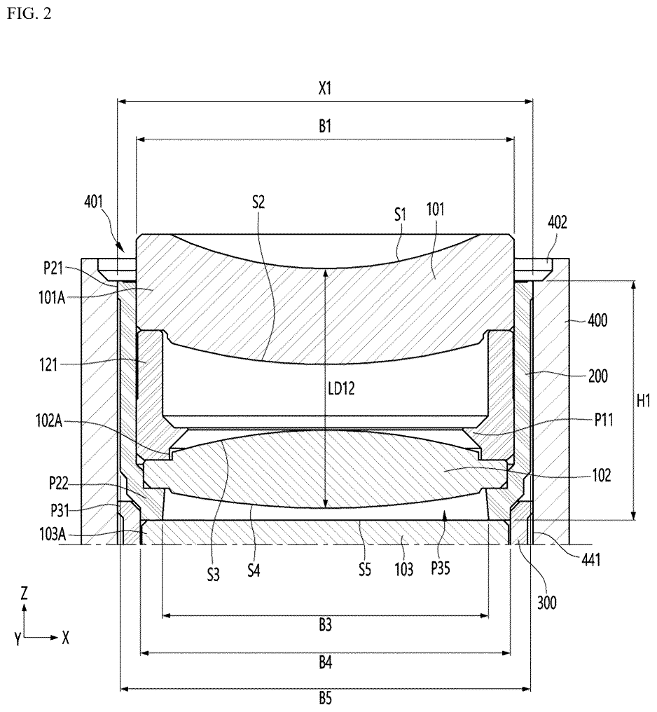

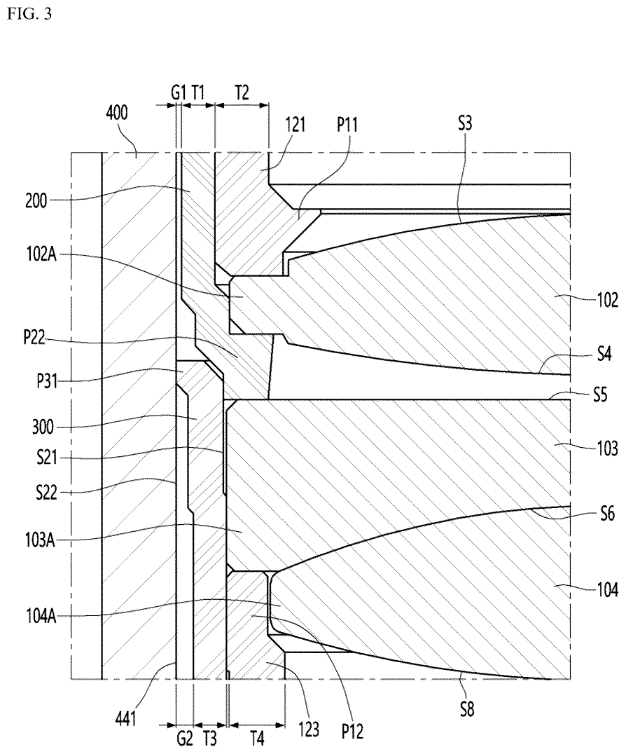

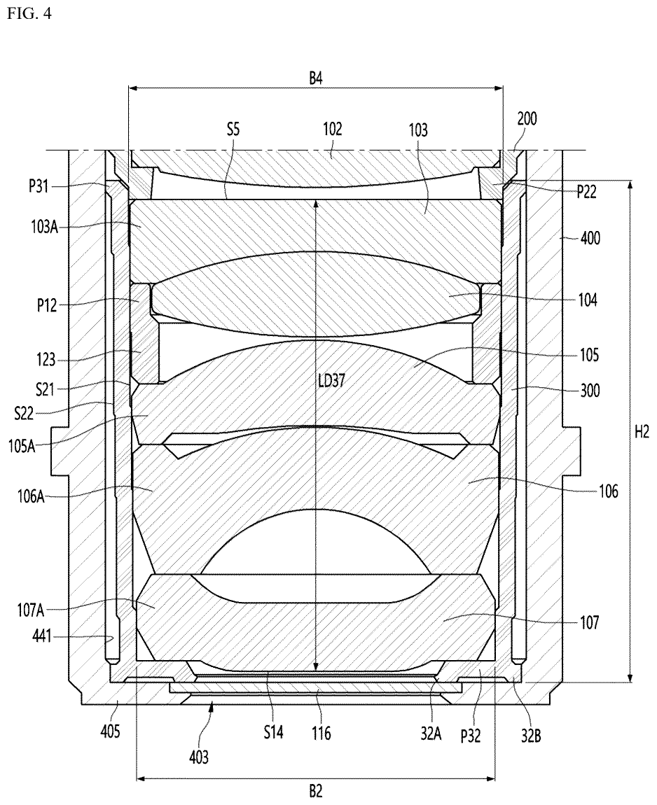

FIG. 1 is a side cross-sectional view of a camera module according to an embodiment of the invention, FIG. 2 is a view showing an upper region of the lens barrel in the camera module of FIG. 1, FIG. 3 is a diagram explaining an example of coupling the first and second inner barrels of the camera module of FIG. 1, and FIG. 4 is a diagram showing the lower region of the camera module of FIG. 1.

Referring to FIGS. 1 to 4, the camera module 1000 according to an embodiment of the invention includes a lens portion 100 having a plurality of lenses, a lens barrel 400 in which a plurality of lenses is stacked, a plurality of inner barrels 200 and 300 disposed between the plurality of lenses, and spacers 121 and 123 disposed between flange portions of adjacent lenses. The lens barrel 400 may be penetrated from upper portion to lower portion. That is, the lens barrel 400 has a first opening portion 401 on an upper side and a second opening option 403 on a lower side, and the first opening portion 401 and the second opening portion 403 may be connected to each other.

The lens barrel 400 is an outer barrel, and a distance between an outer surface of the lenses and an inner surface 441 of the lens barrel 400 may be 2.5 mm or less, for example, in a range of 0.7 mm to 2.5 mm. When a distance between the outer surface of the lenses and the inner surface 441 of the lens barrel 400 is smaller than the above range, it is not easy to combine the lenses, and when the distance is greater than the above range, a size of the lens barrel may increase or the lens may be tilted with respect to the optical axis.

The camera module 1000 may include a substrate 110 and an image sensor 112. The image sensor 112 may be disposed on the substrate 110. The image sensor 112 may be disposed between the last lens of the lens portion 100 and the substrate 110. The image sensor 112 may be mounted, seated, contacted, fixed, temporarily fixed, supported, or coupled to a surface of the substrate 110. According to another example, a groove or hole (not shown) capable of accommodating the image sensor 112 may be formed in the substrate 110. The embodiment is not limited to a specific form in which the image sensor 112 is disposed on the substrate 110. The substrate 110 may be a rigid PCB or FPCB. The image sensor 112 may be disposed on the optical axis of the lens portion 100 or on an axis perpendicular to the optical axis of the lens portion 100. In this case, a reflective member such as a prism may be disposed between the lens portion 100 and the image sensor 112. The image sensor 112 may perform a function of converting light passing through the lens portion 100 into image data. The image sensor 112 may be one of a charge coupled device (CCD), complementary metal-oxide semiconductor (CMOS), CPD, or CID. When there are multiple image sensors 112, one may be a color (RGB) sensor and the other may be a black-and-white sensor.

The camera module 1000 may include a cover glass 114 and an optical filter 116 disposed between the last lens of the lens portion 100 and the image sensor 112. The optical filter 116 may be disposed between the lens portion 100 and the image sensor 112. The optical filter 116 may filter light corresponding to a specific wavelength range for light passing through the lenses. The optical filter 116 may be an infrared (IR) blocking filter that blocks infrared rays or an ultraviolet (UV) blocking filter that blocks ultraviolet rays, but the embodiment is not limited thereto. The optical filter 116 may be disposed on the image sensor 112. The optical filter 116 is disposed in the second opening portion 403 of the lens barrel 400 to filter light of a specific wavelength traveling to the lower portion of the lens barrel 400. The cover glass 114 is disposed between the optical filter 116 and the image sensor 112, protects the upper portion of the image sensor 112, and prevents the reliability of the image sensor 112 from deteriorating.

The lens portion 100 may include an optical system in which three or more lenses are stacked, or an optical system in which five or more lenses are stacked. The lens portion 100 may include three to nine lenses. The lens portion 100 may include a plurality of solid lenses. The lens portion 100 may include lenses made of different materials, for example, a plastic lens and a glass lens. For example, the lens portion 100 may include one or more plastic lenses and two or more sheets of glass. The ratio of the number of plastic lenses to the number of glass lenses may be 1:2 to 1:6. The number of lenses made of glass may be greater or smaller than the number of plastic lenses. Alternatively, the lenses of the lens portion 100 may be made of the same glass material or plastic material. The lenses in the lens portion 100 may include a spherical lens and an aspherical lens. Alternatively, the lenses within the lens portion 100 may include spherical lenses. Alternatively, the lenses within the lens portion 100 may include aspherical lenses. Here, the spherical lens is a lens in which the object-side surface and the sensor-side surface of the lens on the optical axis are spherical. The aspherical lens has an object-side surface and a sensor-side surface of the lens on the optical axis. The spherical lens may be made of glass. The aspherical lens may be made of plastic or glass mold.

In the lens portion 100 according to an embodiment of the invention, a number of lenses made of glass may be one or more than a number of lenses made of plastic. Here, the lens portion 100 may be stacked with plastic lenses or/and glass lens(s). The coefficient of linear thermal expansion (CTE) of the plastic material is more than 5 times higher than that of the glass material, and the change value of the refractive index as a function of temperature may be more than 10 times higher for the plastic material than for the glass material. However, since plastic lenses are easier to manufacture and more convenient to design than glass lenses, the demand for their use is increasing. Additionally, the glass mold material may provide an aspherical surface, which may improve thin lens thickness and optical properties. An embodiment of the invention may reduce the weight of the camera module by further mixing plastic lenses into the camera module 1000, provide a cheaper manufacturing cost, and suppress degradation of optical properties due to temperature changes. Various types of plastic lenses may replace glass lenses, and polishing and processing of lens surfaces such as aspherical surfaces or free-form surfaces may be easy.

The lens having the maximum effective diameter within the camera module 1000 may be any one of the first to fourth lenses 101, 102, and 103 arranged from the object side. Preferably, the lens having the maximum effective diameter may be made of glass. The effective diameter may be the diameter of an effective region where effective light enters each lens. The effective diameter is the average of the effective diameter of the object-side surface of each lens and the effective diameter of the sensor-side surface.

Each of the lenses may include an effective region and a non-effective region. The effective region is an area through which light incident on each of the lenses passes. That is, the effective region may be defined as an effective region or effective diameter in which the incident light is refracted to realize optical characteristics. The non-effective region may be arranged around the effective region and may be defined as a flange portion. The non-effective region may be a region where effective light does not enter the plurality of lenses. That is, the non-effective region may be a region unrelated to the optical characteristics. Additionally, an end of the non-effective region may be a region fixed to a structure accommodating the lens.

The lens barrel 400 penetrates from the upper portion to the lower portion, and a plurality of lenses are coupled therein. The plurality of lenses may be coupled through the first opening portion 401 of the lens barrel 400. The plurality of lenses may be sequentially stacked from the lens 107 closest to the sensor side to the lens 101 closest to the object side. As another example, the lenses may be coupled toward the object through the sensor-side opening portion, or may be coupled in both directions. The lens closest to the object side may be the first lens 101, and the sensor-side lens closest to the optical filter 116 or the image sensor 112 may be the n-th lens or the last lens 107, the n may be an integer of 5 or more, for example, any one of 5, 6, 7, 8, and 9.

Hereinafter, for convenience of explanation, an example of a structure in which seven lenses are sequentially stacked in the lens barrel 400 starting from the sensor side will be described. The lens portion 100 may have a plurality of lenses aligned along the optical axis from the object side toward the image sensor 112, for example, a first lens 101, a second lens 102, a third lens 103, a fourth lens 104, a fifth lens 105, a sixth lens 106, and a seventh lens 107 may be aligned. The second lens 102 may be disposed between the first lens 101 and the third lens 103. The fourth lens 104 is disposed between the third lens 103 and the fifth lens 105, and the sixth lens 106 may be disposed between the fifth lens 105 and the seventh lens 107. The lens portion 100 may include a cemented lens in which two adjacent lenses are bonded. The cemented lens may include bonded second and third lenses, bonded third and fourth lenses, or bonded fifth and sixth lenses. The cemented lenses have opposite refractive powers and may compensate for chromatic aberration.

The first lens 101 may be made of glass or plastic. The first lens 101 may have positive (+) or negative (−) refractive power on the optical axis OA. The first lens 101 may have negative (−) refractive power. The first lens 101 is disposed closest to the object among the lenses, and may have, for example, an object-side first surface S1 that is concave on the optical axis and a sensor-side second surface S2 that is convex. Since the object-side first surface of the first lens 101 has a concave shape on the optical axis, problems of contact with external structures or damage from external impacts may be prevented. Additionally, the first lens 101 may be made of glass. The first lens 101 may be provided in an injection molded shape made of glass, and the first surface S1 of the object side and the second surface S2 of the sensor side may be aspherical. As another example, the first lens 101 may have a convex first surface S1 and a concave second surface S2 on the optical axis, and the first lens 101 may have a convex object-side surface. The amount of incident light can be increased through this. Alternatively, the first lens 101 may have a concave shape on both sides of the optical axis.

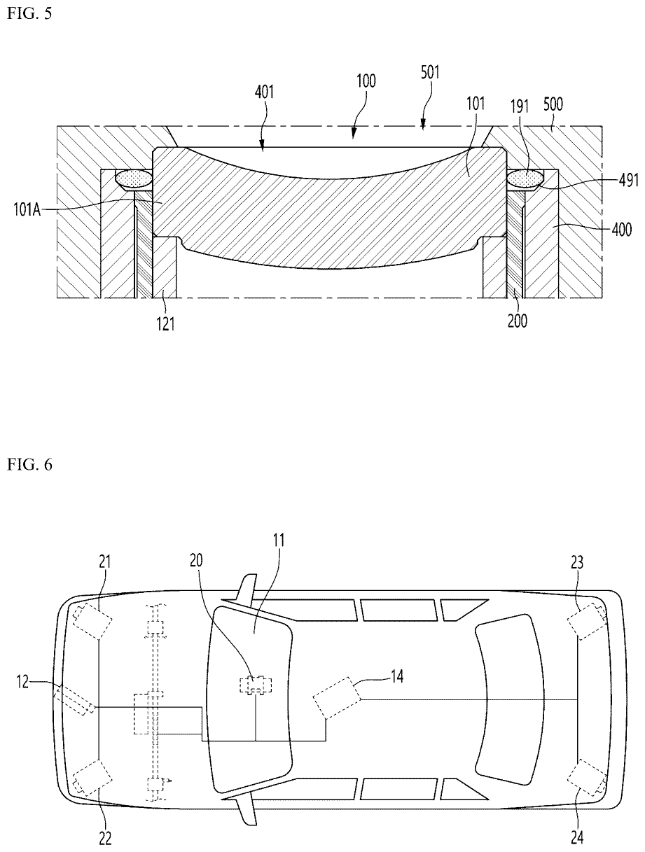

The first lens 101 made of glass may reduce changes in the center position and radius of curvature due to temperature changes depending on the surrounding environment, and protect the incident side surface of the optical system 1000. Additionally, the flange portion 101A of the first lens 101 may have a flat surface on the object side, and the flat surface may block foreign substances from entering from the outside. Since the first lens 101 is made of a mold material, adhesion to the cover 500 (see FIG. 5) may be improved. As shown in FIG. 5, a cover 500 is coupled to the upper circumference of the flange portion 101A of the first lens 101, and the cover 500 may be coupled to the upper circumference of the lens barrel 400.

The camera module 1000 according to the embodiment may include an aperture stop. The aperture stop may control the amount of light incident on the optical system 1000. The aperture stop may be placed at a set position. For example, the aperture stop may be a first spacer 121 disposed on a circumference between the first lens 101 and the second lens 102. Alternatively, a light blocking material coated on the surface of the first spacer 121 may function as an aperture stop. Alternatively, a circumference of the sensor-side surface of the first lens 101 or the object-side surface of the second lens 102 may be coated with a light-blocking material to function as an aperture stop to adjust the amount of light. The first spacer 121 is disposed on a circumference between the first and second lenses 101 and 102 and may maintain the outer distance between the first and second lenses 101 and 102. The first spacer 121 may have a ring shape. The outer surface of the first spacer 121 may not be in contact with the inner surface 441 of the lens barrel 400, or may be spaced apart. The first spacer 121 may be made of a metallic or non-metallic material, for example, aluminum or plastic. The inner protrusion P11 of the first spacer 121 may extend around the object-side surface of the second lens 102. The inner protrusion P11 of the first spacer 121 may function as an aperture stop.

The second lens 102 may have positive (+) or negative (−) refractive power at the optical axis OA. The second lens 102 may have positive (+) refractive power. The second lens 102 may have both surfaces S3 and S4 convex on the optical axis. Alternatively, the second lens 102 may have a concave object-side third surface S3 and a convex sensor-side fourth surface S4 on the optical axis. Alternatively, the second lens 102 may have a meniscus shape that is convex toward the object or a shape that is concave on both sides. The second lens 102 may be made of plastic or glass, for example, glass. The object-side surface and the sensor-side surface of the second lens 102 may be spherical.

The third lens 103 may have positive (+) or negative (−) refractive power on the optical axis OA. The third lens 103 may include an object-side fifth surface S5 that is flat or concave on the optical axis and a concave sensor-side sixth surface S6. Alternatively, the third lens 103 may have a convex object-side surface and a convex sensor-side surface on the optical axis. Alternatively, the third lens 103 may have a meniscus shape that is convex toward the sensor or a shape that is convex on both sides. The third lens 103 may be made of plastic or glass, for example, glass. The object-side surface and the sensor-side surface of the third lens 103 may be spherical.

The fourth lens 104 may have positive (+) or negative (−) refractive power on the optical axis OA. For example, the fourth lens 104 may have a convex object-side seventh surface and a convex sensor-side eighth surface S8 on the optical axis. Alternatively, the fourth lens 104 may have a meniscus shape that is convex toward the sensor or a shape that is concave on both sides. The fourth lens 104 may be made of plastic or glass, for example, glass. The object-side surface and the sensor-side surface of the fourth lens 104 may be spherical.

The third lens 103 and the fourth lens 104 may be bonded lenses bonded together. The sensor-side sixth surface S6 of the third lens 103 and the object-side surface of the fourth lens 104 may be bonded. The third and fourth lenses 103 and 104 may have opposite refractive powers. The combined refractive power of the third and fourth lenses 103 and 104 may have positive (+) or negative refractive power. The product of the refractive power of the object-side lens and the refractive power of the sensor-side lens of the cemented lens may be less than 0. The product of the focal length of the object-side lens and the focal length of the sensor-side lens of the cemented lens may be less than 0. Accordingly, the aberration characteristics of the optical system may be improved. When the refractive powers of the two lenses of a cemented lens are the same, there is a limit to improving aberrations. As another example, the third lens 103 and the fourth lens 104 may not be bonded.

The diameter of the fourth lens 104 may be larger than the diameter of the third lens 103, and the protrusion P12 of the second spacer 123 may be disposed on the outer surface of the fourth lens 104. there is. The second spacer 123 is disposed on the outer circumference between the flange portion 103A of the third lens 103 and the flange portion 105A of the fifth lens 105, and may maintain the distance between the third and fifth lenses 103 and 105. The protrusion P12 of the second spacer 123 may be spaced apart from or adhered to the outer surface of the third lens 103. The thickness between the outer surface and the inner surface of the protrusion P12 may be smaller than the distance T4 between the inner surface and the outer surface of the second spacer 123, that is, the thickness. The second spacer 123 may be made of a metal or non-metal material, and may be, for example, aluminum, copper, or plastic.

The fifth lens 105 may have positive (+) or negative (−) refractive power on the optical axis (OA). The fifth lens 105 may include plastic or glass. For example, the fifth lens 105 may have a convex object-side surface and a concave sensor-side surface on the optical axis. Alternatively, the fifth lens 105 may have a meniscus shape that is convex toward the sensor or a shape that is concave on both sides. The object-side surface and the sensor-side surface of the fifth lens 105 may be spherical or aspherical. As another example, fourth and fifth lenses may be bonded to each other within the lens barrel, the fourth and fifth lenses may have opposite refractive powers, and the two bonded lenses may be made of the same glass material.

The sixth lens 106 may have positive (+) or negative (−) refractive power on the optical axis OA. The sixth lens 106 may include plastic or glass. The sixth lens 106 may have a convex object-side surface and a concave sensor-side surface on the optical axis. The sixth lens 106 may have a meniscus shape convex toward the object. Alternatively, the sixth lens 106 may have a meniscus shape that is convex toward the sensor on the optical axis or a shape that is concave on both sides. The object-side surface and the sensor-side surface of the sixth lens 106 may be aspherical. As another example, the fifth and sixth lenses may be bonded to each other within the lens barrel, the product of the refractive powers of the fourth and fifth lenses may be less than 0, and the two bonded lenses may be made of the same glass material.

The seventh lens 107 may have positive (+) or negative (−) refractive power on the optical axis OA. The seventh lens 107 may have negative refractive power. The seventh lens 107 may include plastic or glass. For example, the seventh lens 107 may be made of plastic. The seventh lens 107 may have a meniscus shape convex toward the object on the optical axis. Alternatively, the seventh lens 107 may have a meniscus shape that is convex toward the sensor on the optical axis OA, or may have a shape that is concave on both sides. The object-side surface and the sensor-side surface of the seventh lens 107 may be aspherical.

The seventh lens 107 may be a plastic lens closest to the image sensor 400. By arranging the plastic lens closest to the image sensor 112, optical performance may be improved by the lens surface having an aspherical surface, thereby improving aberration characteristics and controlling the effect on resolution. Additionally, by placing a plastic lens as the lens closest to the image sensor 112, it may be insensitive to assembly tolerances compared to a glass lens. In other words, being insensitive to assembly tolerances means that optical performance may not be significantly affected even when the assembly is assembled with a slight difference compared to the design.

When the first and second spacers 121 and 123 are made of metal, heat transferred from the lenses may be conducted to the lens barrel 400 or the inner barrel 300 and 400. That is, when the first and second spacers 121 and 123 are made of a heat dissipating material, they may dissipate heat conducted through the flange portion of the lens made of glass. When the spacers 121 and 123 are made of metal, the spacers 121 and 123 may include at least one of In, Ga, Zn, Sn, Al, Ca, Sr, Ba, W, U, Ni, Cu, Hg, Pb, Bi, Si, Ta, H, Fe, Co, Cr, Mn, Be, B, Mg, Nb, Mo, Cd, Sn, Zr, Sc, Ti, V, Eu, Gd, Er, Lu, Yb, Ru, Y and La. The oxide film may be an oxidized material treated with black oxide or brown oxide using copper. Here, the lens barrel 400 may be made of a metal or non-metal material, for example, aluminum or copper. Accordingly, when the lens barrel 400 is made of a metal material, heat generated from the spacers 121 and 123 and the flange portion of each lens may be dissipated, thereby improving the optical characteristics according to temperature changes of the camera module exposed to the outside. Reliability degradation may be prevented.

The inner opening portion of the lens barrel 400 may have an upper diameter X1 larger than a lower diameter X2. Here, the upper diameter X1 may be the maximum distance of a region corresponding to the outer surface of the flange portion 101A of the first lens 101. The lower diameter X2 may be the maximum distance of a region corresponding to the outer surface of the flange portion 107A of the last lens 107. Since the diameter satisfies the condition: X2<X1, the lenses may be coupled toward the sensor side through the object side. In this case, a diameter B1 of the first lens 101 may be larger than a diameter B2 of the last seventh lens 107. The diameters B1 and B2 are the maximum diameters between the outer surfaces of the flange portions 101A and 107A of each lens 101 and 107.

As shown in FIG. 1, the lens barrel 400 may include a plurality of inner barrels 200 and 300 therein. The number of inner barrels may be smaller than the number of lenses in the lens barrel 400, for example, in a range of n−2 to n−5, where n is the number of lenses and ranges from 4 to 9. Here, at least one of the upper portion, center portion, and lower portion of the inner barrel may be disposed on the outer surface of at least one lens. That is, at least one of the upper portion, center portion, and lower portion of the inner barrel may be disposed between the outer surface of at least one lens and the lens barrel. Accordingly, the outer surfaces of the lens barrel 400 and the lenses may be spaced apart from each other. The thermal expansion coefficient of the inner barrels 200 and 300 may be made of a material that is higher than that of the lens barrel 400. For example, the lens barrel 400 may be made of a metal, such as aluminum, and the inner barrel may be made of a non-metal, such as resin or plastic. The lens barrel 400 may have a thermal expansion coefficient of less than 30, and the inner barrel may have a thermal expansion coefficient of 50 or more. The difference in thermal expansion coefficient between the inner barrel and the lens barrel may be 20 or more. The difference in thermal expansion coefficient of the inner barrel and the plastic lens may be 3 or less, 2 or less, or the same.

When the lens barrel 400 is injection molded from a metal material, there is a problem in that dimension control is difficult and diameter deviation occurs depending on the inner region. In other words, the inner diameter dimension and decenter management between the inner diameters for aligning the lenses are inferior compared to injection molded products. Additionally, most vehicle lenses in the lens barrel are made of glass. In the case of glass material, dimensional deviations exist due to the processing of each individual product, and in addition, the outer diameter size and decenter management between the outer diameters for lens alignment may be difficult more than those of injection molded products, and the manufacturing cost of the lens is higher than that of injection molded products. Since the invention manufactures the inner barrel as a mold injection and arranges it in the lens barrel, it is possible to minimize the deviation between the inner and outer diameters between the lenses and the lens barrel, and to reduce the tolerance of the glass lens or plastic lens to minimize decenter and tilt due to tolerance. In addition, the inner barrel may maintain resolution according to temperature changes. In other words, stress on the plastic lens may be suppressed and decentering may be minimized according to temperature changes.

The inner barrels 200 and 300 may include materials or particles for blocking or absorbing light on the surface or inside. The inner barrels 200 and 300 may be made of a non-reflective material or a light-absorbing material, thereby blocking interference caused by light reflection. At least one of the upper, inner, and lower portions of the inner barrels 200 and 300 may be in contact with the object-side surface and the sensor-side surface of the flange portion of at least one lens. The inner barrels 200 and 300 may be made of the same material or different materials. The inner barrels 200 and 300 may be made of plastic. Each of the inner barrels 200 and 300 has a through hole therein, and at least one lens may be coupled to of the upper, inner, and lower portions of the inner through hole. The distance T1 (i.e., the thickness) between the inner surface and the outer surface of each of the inner barrels 200 and 300 may be smaller than the distance (i.e., thickness) between the inner surface 441 and the outer surface of the lens barrel 400. Here, the distance or thickness between the inner surface and the outer surface may be a distance between the inner surface and the outer surface having a vertical plane in a region corresponding to the outer surface of the lens.

As shown in FIGS. 1 to 4, the inner barrels 200 and 300 may be placed inside the outer barrel, that is, the lens barrel 400. The inner barrels 200 and 300 may include a first inner barrel 200 coupled to an inner upper portion of the lens barrel 400 and a second inner barrel 300 coupled to an inner lower portion. The first inner barrel 200 may be coupled to the upper periphery of the lens barrel 400. At least one lens may be disposed inside the first inner barrel 300, for example, a plurality of lenses 101 and 102 may be disposed inside the first inner barrel 300. The first inner barrel 300 may be disposed on the outer surfaces of the first and second lenses 101 and 102. The first and second lenses 101 and 102 or the inner lenses of the first inner barrel 200 are defined as upper lenses.

The first inner barrel 300 may be disposed between the first and second lenses 101 and 102 and the lens barrel 400. The outer surface of the upper lens may be spaced apart from the outer surface of the lens barrel 400, for example, more than the distance T1 between the inner surface and outer surface of the first inner barrel 200, that is, more than the thickness. That is, the distance between the outer surface of at least one of the first and second lenses 101 and 102 and the lens barrel 400 may be in the range of 0.7 mm to 2 mm. The upper inner surface of the first inner barrel 200 faces the outer surface of the first flange portion 101A of the first lens 101, and the lower inner surface faces the outer surface the second flange portion 102A of the second lens 102. The first and second lenses 101 and 102 may be attached to the first inner barrel 200 with an adhesive. The first spacer 121 is located inside the first inner barrel 200 and may separate the first and second lenses 101 and 102.

The thickness T1 of the first inner barrel 200 may be smaller than the thickness T2 of the first spacer 121. The thickness T2 of the first spacer 121 is a horizontal distance in the region between the first and second lenses 101 and 102.

The upper portion of the first inner barrel 200 may extend to the outer surface of the first lens 101, and the lower portion may extend to the outer surface of the second lens 102. The first inner barrel 200 includes a first outer upper protrusion P21 protruding outward, and the first outer upper protrusion P21 may face the upper end portion of the inner surface 441 of the lens barrel 400. The upper end of the first inner barrel 200 is located at the center of the outer surface of the first flange portion 101A of the first lens 101 and may be located lower than the upper end of the first flange portion 101A. The upper end of the first inner barrel 200 may be exposed on the first opening portion 401.

The first outer upper protrusion P21 may have a first minimum distance from the inner surface 441 of the lens barrel 400, and the first minimum distance may be an interval that may flow when at least one of the first and second lenses 101 and 102 is expanded in a horizontal direction, and may be 0.1 mm or less, for example, in the range of 0.05 mm to 0.1 mm. When the lens barrel 400 is made of metal, the first inner barrel 200 is made of plastic, and at least one of the first and second lenses 101 and 102 is made of glass, the first minimum distance may be the maximum distance that may be expanded when the lenses 101 and 102 are thermally expanded in the horizontal direction at a high temperature, that is, in the range of 85 degrees to 105 degrees. The horizontal direction may be perpendicular to the optical axis. This first minimum distance has the effect of separating the inner barrel and the lens barrel so that they do not contact each other even if the plastic lens expands at high temperature, or does not cause significant stress to the lens even if they do contact. Additionally, when the lens, inner barrel, etc. expand/contract at high/low temperatures, the shape of the inner barrel may be provided in a structure where the changing positions do not affect each other.

As shown in FIG. 3, the first inner barrel 200 and the lens barrel 400 may have a first distance G1. The first distance G1 is a distance between the outer surface of the first inner barrel 200 and the inner surface 441 of the lens barrel 400 at the center portion of the first inner barrel 200. The center portion of the first inner barrel 200 is a region corresponding to the distance between the first lens 101 and the second lens 102. The first distance G1 may be larger than the first minimum distance, and is more than the distance at which the first and second lenses may flow when expanded in the horizontal direction, and may be 0.5 mm or less, for example, in a range of 0.1 mm to 0.5 mm. When the first inner barrel 200 is made of plastic and the lenses 101 and 102 are made of glass, the first distance G1 may be a maximum distance that is expandable when the lens is thermally expanded in the horizontal direction at a high temperature, that is, in a range of 85 degrees to 105 degrees. The first distance G1 may be 10% or more, for example, 10% to 50% of the thickness of the first inner barrel 200, that is, the distance T1 between the inner and outer surfaces. When the first distance G1 is smaller than the above range, a problem may occur in which at least one of the first and second lenses 101 and 102 is tilted with respect to the optical axis due to temperature changes, and when it is larger than the above range, there are difficulties in the support and fixing force the inner lenses.

The first inner barrel 200 may include a first support spacer P22 at the lower inner side. A first support spacer P22 is integrally formed from the lower portion of the first inner barrel 200 and may be disposed around the region P25 between the second lens 102 and the third lens 103. The first support spacer P22 is disposed between the second flange portion 102A of the second lens 102 and the third flange portion 103A of the third lens 103, and may separate the second and third flange portions 102A and 103A from each other.

The first support spacer P22 may overlap the first spacer 121 in the vertical direction or the optical axis direction. The inner diameter B3 of the first support spacer P22 may be smaller than the upper inner diameter of the first inner barrel 200, that is, the diameter B1 of the first lens 101. The first support spacer P22 may function as a support portion at the lower portion of the first inner barrel 200. This is because the height H1 of the first inner barrel 200 is placed higher than a predetermined level, so the support force in the vertical direction may be reduced, and the first support spacer P22 may be used as a bottom support portion.

The height H1 of the first inner barrel 200 may be greater than the center thickness of the first lens 101. The height H1 of the first inner barrel 200 may be greater than the sum of the center thicknesses of the first and second lenses 101 and 102. The height H1 of the first inner barrel 200 may be greater than or equal to the optical axis distance LD12 from the center of the object-side surface S1 of the first lens 101 to the center of the sensor-side surface S4 of the second lens 102. The height H1 of the first inner barrel 200 may be smaller than an optical axis distance from the center of the object-side surface S1 of the first lens 101 to the center of the object-side surface S5 of the third lens 103.

When the height H1 of the first inner barrel 200 varies from the center of the object-side surface S1 of the first lens 101 to the center of the object-side or sensor-side surface S6 of the third lens 103, a size of the support portion may not be expanded, and thus the support strength in the vertical direction may be reduced.

As shown in FIGS. 1, 3, and 4, the second inner barrel 300 may be disposed on the outer surface of two or more lenses, for example, on the outer surface of two to six lenses. The second inner barrel 300 may extend between the outer surface of the third to seventh lenses 103 to 105 and the inner surface 441 of the lens barrel 400. Hereinafter, for convenience of explanation, the third to seventh lenses 103 to 107 or the inner lenses of the second inner barrel 300 will be defined as lower lenses. The second inner barrel 300 may have a through hole into which the lower lenses is inserted. The upper portion of the second inner barrel 300 may overlap the upper portion of the first inner barrel 200 in a vertical direction. The upper portion of the second inner barrel 300 extends to the outside of the first support spacer P22 of the first inner barrel 200 and may overlap the first support spacer P22 in the horizontal direction.

The second inner barrel 300 is disposed on the outer surfaces of the lower lenses 103 to 107, and the outer surfaces of the lower lenses 103 to 107 may be spaced apart from the outer surface of the lens barrel 400, and may be spaced apart, for example, by a distance T3 or more between the inner and outer surfaces of the second inner barrel 300, that is, a thickness or more. That is, the distance between the outer surface of at least one of the lower lenses and the lens barrel 400 may be in the range of 0.7 mm to 2 mm.

The inner surface of the second inner barrel 300 may face the outer surface of the flange portions 103A, 105A, 106A, and 107A of the third, fifth, sixth, and seventh lenses 103, 105, 106, and 107. The third, fifth, sixth, and seventh lenses 103, 105, 106, and 107 may be attached to the second inner barrel 300 with an adhesive. The second spacer 123 is located inside the second inner barrel 300 and may separate the third and fifth lenses 103 and 105. The fourth lens 104 faces the inner surface of the second spacer 123, and the outer surface of the fourth lens 104 may be adhered to the second spacer 123 using an adhesive. The thickness T3 of the second inner barrel 300 may be smaller than the thickness T4 of the second spacer 123. The thickness T4 of the second spacer 123 is the horizontal distance in the region between the fourth and fifth lenses 104 and 105.

The upper portion of the second inner barrel 300 may extend to the outer surface of the third lens 103, and the lower portion may extend to the outer surface of the seventh lens 107. The second inner barrel 300 includes a second outer upper protrusion P31 protruding outward from the upper portion, and the second outer upper protrusion P31 may face the center portion of the inner surface 441 of the lens barrel 400. The second outer upper protrusion P31 may have a second minimum distance from the inner surface 441 of the lens barrel 400, and the second minimum distance may be a distance that may flow when at least one of the lower lenses is expanded in a horizontal direction, and may be 0.1 mm or less, for example, in a range of 0.05 mm to 0.1 mm. When the lens barrel 400 is made of metal, the second inner barrel 300 is made of plastic, and at least one or all of the fifth, sixth, and seventh lenses 105, 106, and 107 are made of plastic, the second minimum distance is may be the maximum distance that may be expanded when the lenses are thermally expanded in the horizontal direction at a high temperature, that is, in the range of 85 degrees to 105 degrees. Alternatively, at least one of the fifth to seventh lenses 105, 106, and 107 may be made of glass.

As shown in FIG. 3, the second inner barrel 300 and the lens barrel 400 may have a second distance G2. The second distance G2 is a distance between the outer surface of the second inner barrel 300 and the inner surface 441 of the lens barrel 400 at the center portion of the second inner barrel 300. The center portion of the second inner barrel 300 is a region corresponding to the distance between the fifth lens 105 and the sixth lens 106. The second distance G2 may be greater than the second minimum distance, and is more than the distance that may flow when at least one of the lower lenses is expanded in the horizontal direction, and is 0.5 mm or less, for example, in a range of 0.1 mm to 0.5 mm. When the second inner barrel 300 is made of plastic and at least one of the fifth to seventh lenses 105, 106, and 107 is made of plastic, the second distance G2 may be a maximum distance that is expandable when the lower lens is thermally expanded in the horizontal direction at a high temperature, that is, in a range of 85 degrees to 105 degrees. The second distance G2 may be 10% or more, for example, 10% to 50% of the thickness of the second inner barrel 300, that is, the distance T3 between the inner and outer surfaces. When the second distance G2 is smaller than the above range, a problem may occur in which at least one of the lower lenses is tilted with respect to the optical axis due to temperature changes, and when it is larger than the above range, there are difficulties in the support and fixing force of the lower lenses.

The second inner barrel 300 may include a second support spacer P32 on the lower inner side. The second support spacer P32 extends integrally from the lower portion of the second inner barrel 300 and may be disposed between the lower locking protrusion 405 of the lens barrel 400 and the last lens 107. The second support spacer P32 is disposed around the flange portion 107A of the last lens 107 and may space the last lens 107 from the surface of the optical filter 116. The bottom protrusions 32A and 32B of the second support spacer P32 may be spaced apart from each other, the inner bottom protrusion 32A may support the upper circumference of the optical filter 116, and the outer bottom protrusion 32B may face the lower end of the inner surface 441 of the lens barrel 400. The bottom protrusions 32A and 32B of the second support spacer P32 are spaced apart on both sides, thereby providing a predetermined elastic repulsion force in the optical axis direction.

The second support spacer P32 may overlap the second spacer 123 in the vertical direction or the optical axis direction. The inner diameter of the second support spacer P22 may be smaller than the width of the optical filter 116 and may be smaller than the upper inner diameter B4 of the second inner barrel 300. The second support spacer P32 may function as a support portion at the lower portion of the second inner barrel 300. This is because the height H2 of the second inner barrel 300 is placed high, the vertical support force may be reduced, and the second support spacer P32 may be used as a bottom support portion. The height H2 of the second inner barrel 300 may be greater than the sum of the center thicknesses of the third and fourth lenses 103 and 104. The height H2 of the second inner barrel 300 may be greater than the sum of the center thicknesses of the third to seventh lenses 103 to 107. The height H2 of the second inner barrel 300 may be greater than the distance LD37 in the optical axis from the center of the object-side surface S5 of the third lens 103 to the center of the sensor-side surface S14 of the seventh lens 107. The height H2 of the second inner barrel 300 may be smaller than a distance in the optical axis from the center of the object-side surface S3 of the second lens 102 to the center of the sensor-side surface S14 of the seventh lens 107.

When the height H2 of the second inner barrel 300 is greater than the optical axis distance from the center of the object-side surface S3 of the second lens 102 to the center of the sensor-side surface S14 of the seventh lens 107, the support strength in the vertical direction may be lowered, so that at least one of the third, fourth, and fifth lenses 103, 104, and 105 may be tilted with respect to the optical axis.

The inner surface S21 of the second inner barrel 300 may have a stepped structure so that the diameter becomes narrower from the upper portion to the lower portion, depending on the difference in effective diameters of the third to seventh lenses 103 to 107. In the stepped structure, upper and lower portions may be stepped based on a center portion of the outer surface of the third lens 103, upper and lower portions may be stepped based on a center portion of the outer surface of the fifth lens 105, upper and lower portions may be stepped based on a center portion of the outer surface of the sixth lens 106, and upper and lower portions may be stepped based on the outer center of the seventh lens 107. When the diameter of the third lens 103 is CA3, the diameter of the fifth lens 105 is CA5, the diameter of the sixth lens 106 is CA6, and the diameter of the seventh lens 107 is CA7, the following Equation may satisfy: CA3<CA5<CA6<CA7.

One of the first, second, and third lenses 101, 102, and 103 may have the largest diameter, and the diameter may gradually decrease from one of the first, second, and third lenses 101, 102, and 103 to the last lens. Accordingly, the distance between the outer surface of the second inner barrel 300 and the inner surface of the lens barrel 400 may gradually increase from the region corresponding to the outer surface of the lens with the larger diameter among the second, third, fourth, and fifth lenses toward the sensor side. The outer surface S22 of the second inner barrel 300 may have a stepped structure following the stepped structure of the inner surface S21. The stepped structure of the outer surface S22 of the second inner barrel 300 may be disposed below the same horizontal line as the stepped structure of the inner surface S21.

Here, when explaining the order of combining the above components, the second inner barrel 300 may be coupled to the lens barrel 400, and then the seventh lens 107 may be stacked on the second inner barrel 300. The sixth lens 106 is stacked on the seventh lens 107, the fifth lens 105 is stacked on the sixth lenses 106, and the second spacer 123 is stacked on the outer circumference of the fifth lens 105, and a cemented lens having third and fourth lenses 103 and 104 may be combined on the second spacer 124. Here, the optical filter 116 may be coupled to the inner bottom of the lens barrel 400 before coupling the lens barrel 400, or may be coupled to the outer lower portion of the lens barrel 400. As another example, a structure combining the third to seventh lenses 103 to 107 and the second spacer 123 inside the second inner barrel 300 may be coupled to the lens barrel 400. As another example, the seventh lens 107 may be seated on the bottom of the lens barrel 400.

When the second inner barrel 300 and the third lens 103 are combined, the first inner barrel 200 is combined within the lens barrel 400, and then the second lens 102 is stacked on the third lens 103, the first spacer 121 may be coupled to the second lens 102, and the first lens 101 may be coupled to the first spacer 121. As another example, the first and second lenses 101 and 102, the first spacer 121, and the first inner barrel 200 may be coupled externally, and then a coupling structure may be coupled inside the lens barrel 400.

The inner barrels 200 and 300 are interlocked in the horizontal direction when at least one of the lenses 101 to 107 within the lens barrel 400 expands or contracts in the horizontal direction according to temperature changes, thereby preventing a decrease in resolution due to temperature changes. In addition, it is possible to reduce the stress on plastic lenses due to temperature changes and minimize decentering of the optical axis. Additionally, compared to a structure in which a glass lens is directly coupled to the lens barrel, the lens coupling tolerance may be reduced, thereby reducing decentering and tilt on the optical axis. Additionally, when a plastic lens is applied with an inner barrel made of plastic, it has the same coefficient of thermal expansion, which may reduce the impact on optical properties due to thermal expansion or contraction. Additionally, by placing the inner barrel between the lens barrel and the outer surface of the lenses, stress that occurs when the lens is in direct contact with the lens barrel may be reduced.

As shown in FIG. 5, it may include a cover 500 coupled to the upper portion of the lens barrel 400. The spacers 121 and 123 are distance maintenance members that may maintain a distance between two adjacent lenses and may function as a light blocking film or a spacing film. The ring member 191 may be disposed around the periphery between the lens barrel 400 and the first lens. The upper inner side 4910 of the lens barrel 400 may have a concave groove or a concave curved shape for coupling the ring member 191. The ring member 191 may be made of an elastic material or a resin material such as silicone or epoxy. As another example, the ring member 191 may be coupled between the lens barrel 400 and the cover. The ring member 191 may perform a waterproof and dustproof function inside and/or outside the lens barrel 400.

FIG. 6 is an example of a top view of a vehicle to which a camera module according to an embodiment of the invention is applied.

Referring to FIG. 6, the vehicle camera system according to an embodiment of the invention includes an image generating unit 11, a first information generating unit 12, second information generating units 21, 22, 23, 24, and a control unit 14. The image generating unit 11 may include at least one camera module 20 disposed in the own vehicle, and may generate a front image of the own vehicle or an image inside the vehicle by photographing the front and/or driver of the own vehicle. In addition, the image generating unit 11 may generate an image captured by the driver or the surroundings of the own vehicle in one or more directions as well as in front of the own vehicle by using the camera module 20. Here, the front image and the surrounding image may be a digital image, and may include a color image, a black-and-white image, and an infrared image. In addition, the front image and the surrounding image may include a still image and a moving image. The image generating unit 11 provides the driver image, the front image, and the surrounding image to the control unit 14. Next, the first information generating unit 12 may include at least one radar and/or a camera disposed on the own vehicle, and generates first detection information by detecting the front of the own vehicle. Specifically, the first information generating unit 12 is disposed in the own vehicle, and generates the first sensing information by detecting the positions and speeds of vehicles located in front of the own vehicle, the presence and location of pedestrians, and the like.

By using the first detection information generated by the first information generating unit 12, it is possible to control to maintain a constant distance between the own vehicle and the vehicle in front, and the stability of vehicle operation may be improved in a preset specific case, such as when the driver wants to change the driving lane of the own vehicle or when reverse parking. The first information generating unit 12 provides the first detection information to the control unit 14. The second information generating unit 21, 22, 23, 24 detect each side of the own vehicle and generate second sensing information based on the front image generated by the image generating unit 11 and the first sensing information generated by the first information generating unit 12. Specifically, the second information generating units 21, 22, 23, and 24 may include at least one radar and/or camera disposed on the own vehicle, and detect the positions and speeds of vehicles located on the side of the own vehicle, or may take a video. Here, the second information generating units 21, 22, 23, and 24 may be disposed on both sides of the front and rear of the own vehicle, respectively. Such the vehicle camera system may include the following camera module, and may protect the vehicle and objects from automatic driving or surrounding safety by providing or processing information obtained through the front, rear, each side or corner region of the own vehicle to the user.

At least one information generating unit of such a vehicle camera system may include the below-described camera module, and information obtained through the front, rear, each side or corner region of the vehicle may be provided or processed to the user to protect the vehicle and the object from automatic driving or ambient safety. An optical system of the camera module according to an embodiment of the invention may be mounted in a vehicle for safety regulation, reinforcement of autonomous driving functions, and increased convenience. In addition, the optical system of the camera module is a part for control such as a lane keeping assistance system (LKAS), a lane departure warning system (LDWS), and a driver monitoring system (DMS), and is applied in a vehicle. Such a vehicle camera module may realize stable optical performance even when ambient temperature changes and provide a module with competitive price, thereby securing reliability of vehicle components.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although described above, this is only an example and does not limit the present invention, and those with ordinary knowledge in the field to which this invention belongs will see that various modifications and applications not illustrated above are possible without departing from the essential characteristics of this embodiment. For example, each component specifically shown in the embodiment may be modified and implemented. In addition, the differences related to these modifications and applications should be construed as being included in the scope of the invention defined in the appended claims.

1. A camera module comprising:
a lens barrel penetrating from an upper portion to a lower portion;
a plurality of inner barrels disposed around an inner circumference of the lens barrel; and
a lens portion having a plurality of lenses disposed inside each of the inner barrels, wherein at least one of the plurality of inner barrels is disposed between two adjacent lenses and between outer surfaces of the two adjacent lenses and the lens barrel,
wherein the plurality of inner barrels overlap each other in a direction of an optical axis.

2. The camera module of claim 1,
wherein the plurality of inner barrels include a first inner barrel extending from an outer surface of a first lens closest to an object to an outer surface of a second lens located on a sensor side of the first lens, and
a second lens barrel extending from an outer surface of a third lens located on a sensor side of the second lens to an outer surface of a last lens adjacent to the lower portion of the lens barrel.

3. The camera module of claim 2,
wherein a lower portion of the first inner barrel includes a first support spacer extending between a flange portion of the second lens and a flange portion of the third lens,
wherein the first support spacer is disposed between the flange portion of the second lens and the flange portion of the third lens.

4. The camera module of claim 2,
wherein a distance between an upper end of an outer side of the first inner barrel and the lens barrel is narrower than a distance between the lens barrel and an outer surface of the first inner barrel disposed outside a region between the first lens and the second lens.

5. The camera module of claim 3,
wherein an upper portion of the second inner barrel extends outside the first support spacer of the first inner barrel,
wherein the upper portion of the second inner barrel is disposed between the first support spacer of the first inner barrel and the lens barrel.

6. The camera module of claim 2,
wherein the second inner barrel includes a second support spacer extending below a flange portion of the last lens,
wherein the second support spacer of the second inner barrel is disposed between the flange portion of the last lens and a lower locking portion of the lens barrel.

7. The camera module of claim 2,
wherein the lens portion includes first to seventh lenses sequentially aligned along an optical axis from an object side toward an image sensor,
wherein the seventh lens is the last lens,
wherein a distance between an outer surface of the second inner barrel and an inner surface of the lens barrel gradually widens from the outer surface of the third lens to an outer surface of a seventh lens.

8. The camera module of claim 2,
wherein an inner diameter of the second inner barrel gradually narrows from the upper portion toward the last lens,
wherein inner and outer surfaces of the second inner barrel have a plurality of stepped structures.

9. The camera module of claim 1,
wherein at least one of the plurality of inner barrels is made of plastic,
wherein at least one of the plurality of lenses is made of plastic.

10. The camera module of claim 2,
wherein the lens barrel is made of metal,
wherein the first and second inner barrels are made of plastic,
wherein at least two lenses disposed in the second inner barrel are made of plastic.

11. The camera module of claim 2, comprising:
a first spacer that separates two adjacent lenses within the first inner barrel; and a second spacer that separates two adjacent lenses within the second inner barrel.

12. The camera module of claim 1, comprising:
an image sensor disposed on a sensor side of the lens barrel;
a cover glass disposed on the image sensor; and
an optical filter disposed between the cover glass and a lens closest to the image sensor,
wherein the lens barrel has a first opening at an the upper portion of the lens barrel and a second opening at the lower portion of the lens barrel, and
wherein the optical filter is disposed within the second opening of the lens barrel.

13. A vehicle comprising:
a camera module having a plurality of lenses, a plurality of inner barrels outside the plurality of lenses, a lens barrel outside the plurality of inner barrels, an optical filter disposed at a lower portion of the lens barrel, and an image sensor disposed on a sensor side of the lens barrel,
wherein the camera module is a camera module according to claim 1,
wherein at least two lenses of the plurality of inner barrels and the plurality of lenses are made of plastic,
wherein the lens barrel has a first opening at the upper portion of the lens barrel and a second opening at a the lower portion of the lens barrel, and
wherein the optical filter is disposed within the second opening of the lens barrel.

14. The camera module of claim 1,
wherein the plurality of inner barrels include first and second inner barrels disposed in the direction of the optical axis from the upper portion to the lower portion of the lens barrel,
wherein the first and second inner barrels are made of a plastic material,
wherein an inner surface of the first inner barrel and outer surfaces of at least two lenses disposed on an inner side of the first inner barrel are bonded to each other.

15. The camera module of claim 1,
wherein the plurality of inner barrels include first and second inner barrels disposed in the direction of the optical axis from the upper portion to the lower portion of the lens barrel,
wherein the first and second inner barrels are made of a plastic material,
wherein an inner surface of the second inner barrel and outer surfaces of at least two lenses disposed on an inner side of the second inner barrel are bonded to each other.

16. The camera module of claim 1,
wherein the plurality of inner barrels include first and second inner barrels disposed in the direction of the optical axis from the upper portion to the lower portion of the lens barrel,
wherein a lower portion of the second inner barrel is disposed between a last lens of the lens portion, which is closest to an optical filter, and a flange portion of the last lens.

17. The camera module of claim 1,
wherein the plurality of inner barrels include first and second inner barrels disposed in the direction of the optical axis from the upper portion to the lower portion of the lens barrel,
wherein the first inner barrel includes a first outer upper protrusion that protrudes upwardly and faces an inner surface of the lens barrel.

18. The camera module of claim 17,
wherein the second inner barrel includes a second outer upper protrusion that protrudes upwardly and faces the inner surface of the lens barrel.

19. The camera module of claim 18,
wherein the second inner barrel has an inner bottom protrusion protruding toward an upper surface periphery of an optical filter disposed at a the lower portion of the lens barrel on a lower inner side of the second inner barrel.

20. The camera module of claim 19,
wherein the second inner barrel has an outer bottom protrusion facing the inner surface of the lens barrel on a lower outer side of the second inner barrel.
